(19) United States
(12) Patent Application Publication
(10) Pub. No.: US 2012/0313868 A1
(43) Pub. Date: Dec. 13, 2012

(54) INFORMATION PROCESSING DEVICE, INFORMATION PROCESSING METHOD AND COMPUTER-READABLE STORAGE MEDIUM

(75) Inventor: Tetsuya Kuromatsu, Tokyo (JP)

(73) Assignee: CASIO COMPUTER CO., LTD., Tokyo (JP)

(21) Appl. No.: 13/474,928

(22) Filed: May 18, 2012

(30) Foreign Application Priority Data
Jun. 9, 2011 (JP) 2011-129512

(51) Int. Cl. G06F 3/041; G06F 3/01

(52) U.S. Cl. 345/173; 345/156

(57) ABSTRACT

An information processing device includes: a first input unit for inputting information through an input operation; a detecting unit for detecting an event that interrupts the input operation of the first input unit; and a second input unit for inputting information through an input operation as an alternative to the first input unit, in a case in which the detecting unit detects the event.

This application is based on and claims the benefit of priority from Japanese Patent Application No. 2011-129512, filed on 9 Jun. 2011, the content of which is incorporated herein by reference.

### BACKGROUND OF THE INVENTION

1. Field of the Invention

The present invention relates to an information processing device, an information processing method as well as a computer-readable storage medium, all of which make it possible to perform an input operation even in a state where an input operation cannot be performed with inputting means that is ordinarily used.

2. Related Art

Conventionally, an information processing device has been known, which performs near field communication with a contactless IC (Integrated Circuit) card in conformity with a communication standard such as NFC (Near Field Communication), reads data stored in the contactless IC card, and utilizes the data for information processing.

As such an information processing device, Patent Document 1 (see Japanese Patent Application, Publication No. 2009-193474) discloses an information processing device, which is configured to be capable of communicating with a contactless IC card, and which includes a keyboard as inputting means that is ordinarily used.

However, in the information processing device disclosed in Patent Document 1, an antenna for communicating with the contactless communication IC card is disposed to surround the keyboard. Therefore, when a user holds the contactless IC card over the vicinity of the antenna, the contactless IC card covers and hides the keyboard, and as a result, an input operation of the keyboard cannot be performed.

### SUMMARY OF THE INVENTION

The present invention has been made in view of such a situation, and an object of the present invention is to provide an information processing device, an information processing method as well as a computer-readable storage medium, all of which make it possible to perform an input operation even in a state where an input operation cannot be performed with inputting means that is ordinarily used.

According to the invention, an information processing device is provided, which includes:

a first input unit which inputs information through an input operation;

a detecting unit which detects an event that interrupts the input operation of the first input unit; and

a second input unit which inputs information through an input operation as an alternative to the first input unit, in a case in which the detecting unit detects the event.

### BRIEF DESCRIPTION OF THE DRAWINGS

FIG. 1A is a top plan view showing an outline of an external appearance configuration of an information processing device in a stand-by state according to an embodiment of the present invention;

FIG. 1B is a top plan view showing an outline of the external appearance configuration of the information processing device in a state where a contactless IC card according to an embodiment of the present invention is held over;

FIG. 2 is a block diagram showing an internal hardware configuration of the information processing device according to an embodiment of the present invention;

FIG. 3 is a functional block diagram showing a functional configuration for executing an input function activation process, among functional configurations of the information processing device shown in FIG. 2; and

FIG. 4 is a flowchart showing a flow of the input function activation process that is executed by the information processing device shown in FIG. 2 having the functional configuration shown in FIG. 3.

### DETAILED DESCRIPTION OF THE INVENTION

Descriptions are provided hereinafter for an embodiment of the present invention with reference to the drawings.

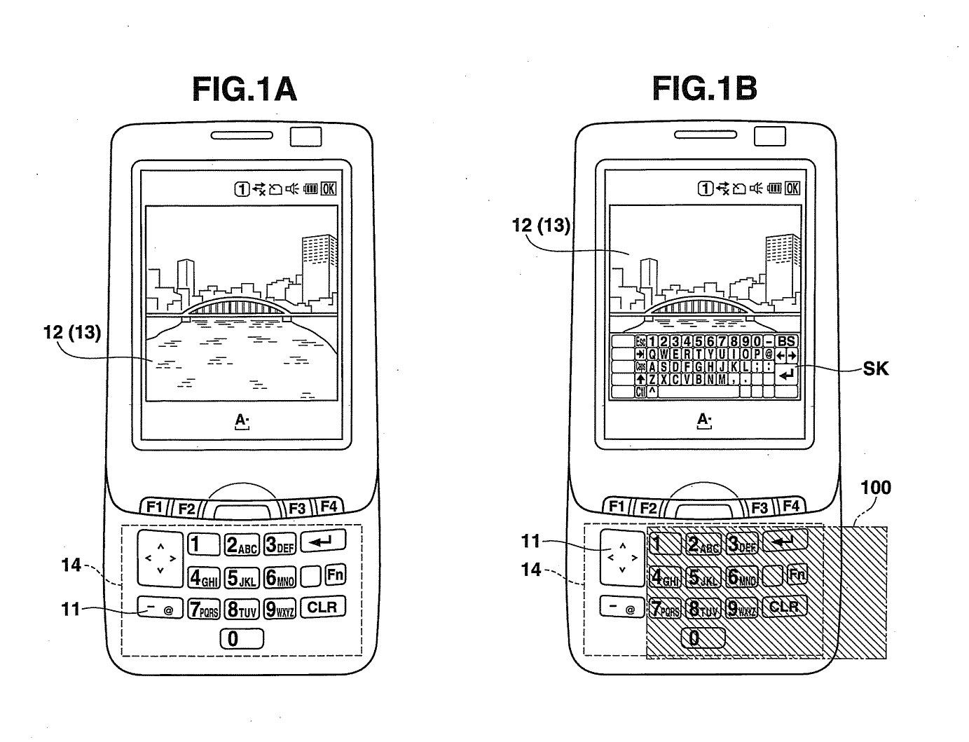

FIG. 1A and FIG. 1B are top plan views showing an outline of an external appearance configuration of an information processing device according to an embodiment of the present invention. More specifically, FIG. 1A is a diagram showing an outline of the external appearance configuration of the information processing device in a stand-by state, and FIG. 1B is a diagram showing an outline of the external appearance configuration of the information processing device in a state where a contactless IC card is held over.

As shown in FIG. 1A, an information processing device 1 includes: a first input unit 11 composed of a keyboard; and a display unit 12 composed of a display, in which the information processing device 1 has a function of communicating with a contactless IC card 100. Therefore, in the information processing device 1, an antenna 14 for communicating with the contactless IC card 100 is disposed to surround the first input unit 11 (the keyboard).

When a user holds the contactless IC card 100 over the vicinity of the antenna 14, i.e. over the first input unit 11, the information processing device 1 transmits and receives data to and from the contactless IC card 100, and executes a variety of information processing. For example, in a case in which the contactless IC card 100 serves as a member's card or an employee ID card of the user, the information processing device 1 executes authentication processing based on data stored in the contactless IC card 100.

Here, as shown in FIG. 1B, holding the contactless IC card 100 over the vicinity of the antenna 14 means covering and hiding the first input unit 11 (the keyboard) with the contactless IC card 100. In this case, the user cannot perform an input operation of the first input unit 11 (the keyboard) that is ordinarily used.

On the other hand, a touch panel as a second input unit 13 is disposed in a laminated manner on the entire display screen of the display unit 12. Even in a case in which the contactless IC card 100 covers the first input unit 11, it is possible to operate an object such as a finger of the user to touch or approach the second input unit 13 (the touch panel) (this operation is hereinafter referred to as “touch operation”).

Accordingly, in a case in which the contactless IC card 100 is held over the information processing device 1 of the present embodiment, the display unit 12 displays an image SK as a GUI (Graphical User Interface) that functions as a software keyboard in conjunction with the second input unit 13 (the touch panel), which functions as alternative inputting means in place of the first input unit 11 (the keyboard).

Here, the “software keyboard” refers to inputting means, in which a touched position corresponds to a predetermined key in the image SK (hereinafter referred to as a software keyboard image SK) as the GUI image displayed on the display unit 12, such an operation is equivalent to an operation of pressing down a predetermined key of the physical keyboard, and information assigned to the predetermined key is input into the information processing device 1.

It should be noted that the physical keyboard (a hardware keyboard) is hereinafter merely referred to as a “keyboard” to clearly distinguish the hardware keyboard from such a software keyboard.

Next, descriptions are provided for an internal configuration of the information processing device 1 having the function as described above.

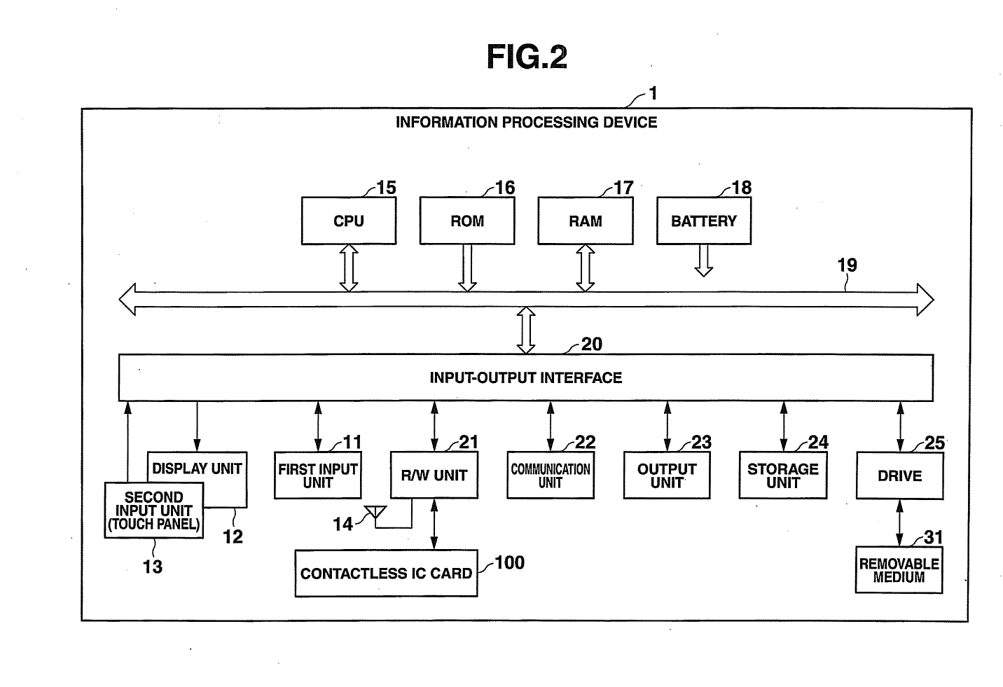

FIG. 2 is a block diagram showing an internal hardware configuration of the information processing device 1 according to an embodiment of the present invention. The information processing device 1 is configured as, for example, a mobile terminal.

The information processing device 1 includes a CPU (Central Processing Unit) 15, ROM (Read Only Memory) 16, RAM (Random Access Memory) 17, a battery 18, a bus 19, an input-output interface 20, the second input unit 13, the display unit 12, the first input unit 11, an R/W unit 21, a communication unit 22, an output unit 23, a storage unit 24, and a drive 25.

The CPU 15 executes various processing in accordance with a program recorded in the ROM 16, or with a program loaded from the storage unit 24 to the RAM 17.

The RAM 17 also appropriately stores data that is necessary for the CPU 15 to execute various processing.

The battery 18 is configured with, for example, a lithium ion secondary battery, and is a power supply that supplies driving electric power to the information processing device 1.

Here, the CPU 15, the ROM 16 and the RAM 17 are mutually connected via the bus 19. The input-output interface 20 is also connected to the bus 19. The second input unit 13, the display unit 12, the first input unit 11, the R/W unit 21, the communication unit 22, the output unit 23, the storage unit 24 and the drive 25 are connected to the input-output interface 20.

As described above, the second input unit 13 is configured as a touch panel that is disposed in a laminated manner on the display unit 12, with which a position touched by the user is input as position coordinates.

The display unit 12 is configured with a display such as an LCD (Liquid Crystal Display), which displays, for example, a wall paper, the software keyboard image SK and the like.

The first input unit 11 is configured with a keyboard composed of a variety of physical keys, and when a predetermined physical key is pressed down, information assigned to the predetermined physical key is input.

The R/W unit 21 performs so-called contactless communication with the contactless IC card 100 in the vicinity thereof via the antenna 14, and reads and writes data stored in the contactless IC card 100.

The communication unit 22 controls communication with other devices (not shown) via a network including the Internet.

The output unit 23 is configured with a speaker or the like, and outputs sound.

The storage unit 24 is configured with a hard disk or DRAM (Dynamic Random Access Memory) to store data of a variety of images, and for example, data of a display state of the display unit 12, etc.

A removable medium 31 composed of a magnetic disk, an optical disk, a magneto-optical disk, semiconductor memory or the like is appropriately mounted to the drive 25. A program that is read from the removable medium 31 by the drive 25 is installed in the storage unit 24 as needed. Moreover, similarly to the storage unit 24, the removable medium 31 can also store a variety of data such as image data stored in the storage unit 24.

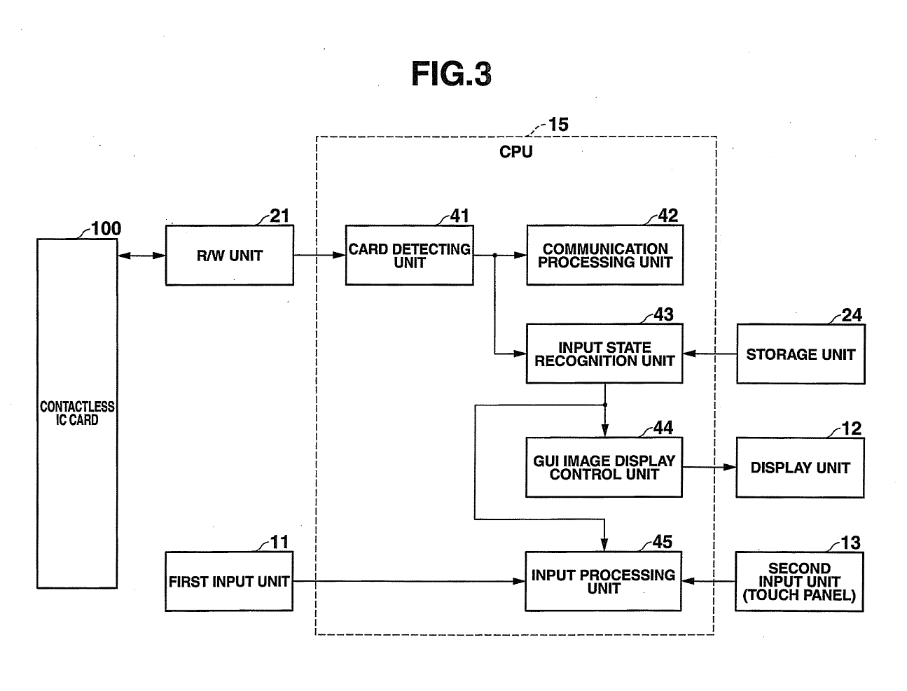

FIG. 3 is a functional block diagram showing a functional configuration for executing an input function activation process, among functional configurations of such an information processing device 1.

The input function activation process is a series of processing, in which the second input unit 13 activates a software keyboard function, in a case in which an input operation is not possible with the first input unit 11, i.e. in a case in which the contactless IC card 100 is held over the vicinity of the antenna 14.

As shown in FIG. 3, in a case in which the input function activation process is executed, a card detecting unit 41, a communication processing unit 42, an input state recognition unit 43, a GUI image display control unit 44, and an input processing unit 45 function in the CPU 15.

The card detecting unit 41 detects the contactless IC card 100, based on contactless communication between the R/W unit 21 and the contactless IC card 100.

Based on a result of detection by the card detecting unit 41, the communication processing unit 42 controls the contactless communication between the contactless IC card 100 and the R/W unit 21, and processes data and the like exchanged in the contactless communication.

Based on a result of detection by the card detecting unit 41, the input state recognition unit 43 recognizes an input state of the first input unit 11 and the second input unit 13. For example, the input state recognition unit 43 recognizes whether an input operation is possible with the second input unit 13. In other words, the input state recognition unit 43 recognizes whether the software keyboard image (for example, the software keyboard image SK as shown in FIG. 1B) is displayed.

Based on a result of recognition by the input state recognition unit 43, the GUI image display control unit 44 controls the display state of the GUI image on the display unit 12. More specifically, in a case in which the input state recognition unit 43 recognizes that an input operation is not possible with the first input unit 11, the GUI image display control unit 44 controls the display unit 12 to display the software keyboard image. On the other hand, in a case in which the input state recognition unit 43 recognizes that an input operation is possible with the first input unit 11, the GUI image display control unit 44 controls the display unit 12 to cancel the displaying of the software keyboard image, as necessary.

The input processing unit 45 processes information that is input via the first input unit 11 or the second input unit 13. For example, in response to information that is input via the first input unit 11 or the second input unit 13, the input processing unit 45 executes processing of an authentication code input, a character input, or the like.

Next, descriptions are provided for the input function activation process that is executed by the information processing device 1.

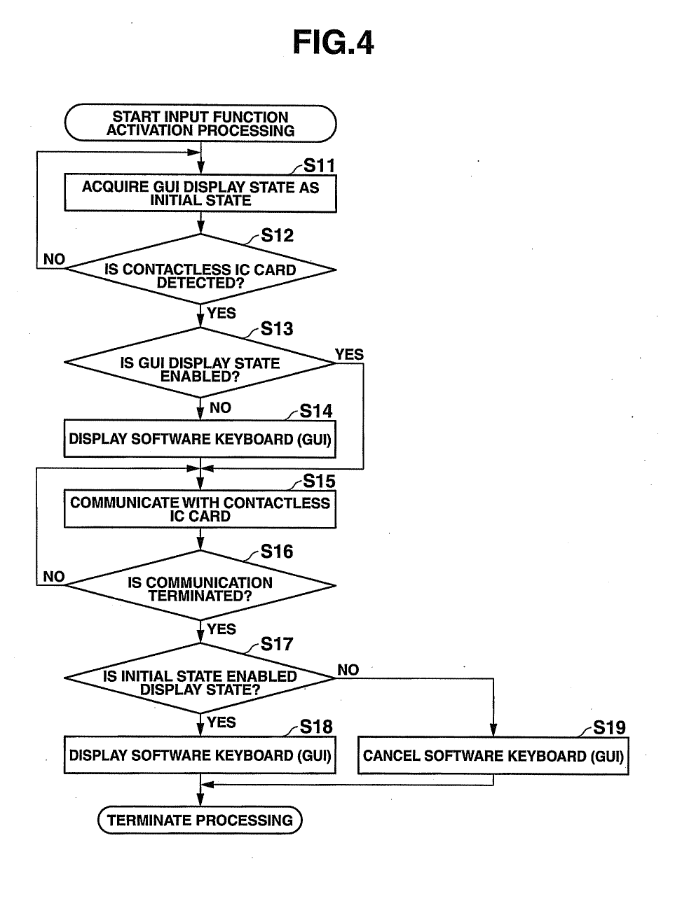

FIG. 4 is a flowchart showing a flow of the input function activation process that is executed by the information processing device 1 shown in FIG. 2 having the functional configuration shown in FIG. 3.

The input function activation process is initiated by the user's operation for starting the input function activation process.

In Step S11, the input state recognition unit 43 recognizes the GUI display state at the point in time as an initial state. In other words, the input state recognition unit 43 recognizes whether an input operation is possible with the second input unit 13, more specifically, the input state recognition unit 43 recognizes whether the software keyboard image (for example, the software keyboard image SK as shown in FIG. 1B) is displayed on the display unit 12. In a case in which the GUI image of the software keyboard is displayed, the input state recognition unit 43 recognizes the GUI display state as an enabled display state; and in a case in which the software keyboard is not displayed, the input state recognition unit 43 recognizes the GUI display state as a disabled display state.

The GUI display state recognized as the initial state in this way is stored in the storage unit 24. In other words, the storage unit 24 stores the fact that the initial state is the enabled display state or the disabled display state.

In Step S12, the card detecting unit 41 determines whether the contactless IC card 100 is detected.

In a case in which the contactless IC card 100 is not detected, the determination in Step S12 is NO, the processing returns to Step S11. In other words, the determination processing in Step S12 is repeatedly executed until the contactless IC card 100 is detected, and the input function activation process is in a stand-by state. Subsequently, when the user holds the contactless IC card 100 over the vicinity of the antenna 14, i.e. over the first input unit 11, the contactless IC card 100 is detected. In such a case, since an input operation is not possible with the first input unit 11, the determination in Step S12 is YES, the processing advances to Step S13, and processing as follows is executed.

In Step S13, the input state recognition unit 43 determines whether the GUI display state is the enabled state. More specifically, the input state recognition unit 43 determines whether the software keyboard image is displayed on the display unit 12.

In a case in which the GUI display state is not the enabled display state (i.e. it is the disabled display state), in other words, in a case in which the software keyboard image is not displayed on the display unit 12, the determination in Step S13 is NO, and the processing advances to Step S14.

On the other hand, in a case in which the GUI display state is the enabled display state, i.e. in a case in which the software keyboard image is displayed on the display unit 12, since an input operation is possible with the second input unit 13 other than the first input unit 11, the determination in Step S13 is YES, and the processing advances to Step S15.

In Step S14, the GUI image display control unit 44 controls the display unit 12 to display the software keyboard image (for example, the software keyboard image SK as shown in FIG. 1B). As a result, the user can perform an input operation with the second input unit 13 in place of the first input unit 11.

In Step S15, the R/W unit 21 performs contactless communication with the contactless IC card 100.

In Step S16, the communication processing unit 42 determines whether the communication is terminated.

In a case in which the communication is not terminated, the determination in Step S16 is NO, the processing returns to Step S15. In other words, the determination processing in Step S16 is repeatedly executed until the communication is terminated. Subsequently, in a case in which the communication is terminated, the determination in Step S16 is YES, the processing advances to Step S17, and processing as follows is executed.

In Step S17, the input state recognition unit 43 determines whether the initial state was the enabled display state. More specifically, the input state recognition unit 43 refers to information regarding the initial state stored in the storage unit 24, and judges the initial display state.

In a case in which the initial state is the enabled display state, the determination in Step S17 is YES, and the processing advances to Step S18.

In a case in which the initial state is not the enabled display state (i.e. it is the disabled display state), the determination in Step S17 is NO, and the processing advances to Step S19, in order to restore the display state of the display unit 12 to an initial state.

In Step S18, the GUI image display control unit 44 controls the display unit 12 to display (continue to display) the software keyboard image (for example, the software keyboard image SK as shown in FIG. 1B). As a result, the input function activation process is terminated.

In Step S19, the GUI image display control unit 44 cancels the software keyboard image. In other words, as a result of termination of the communication, the contactless IC card 100 is no longer held over, and an input operation is now possible with the first input unit 11; accordingly, the display unit 12 cancels the software keyboard image. As a result, the input function activation process is terminated.

In this way, the information processing device 1 makes it possible to perform an input operation even in a state where an input operation cannot be performed with the first input unit 11 that is ordinarily used.

The information processing device 1 with the configuration described above includes the first input unit 11, the card detecting unit 41, and the second input unit 13.

Information is input with the first input unit 11 through an input operation.

The card detecting unit 41 detects an event that interrupts an input operation of the first input unit 11.

In a case in which the card detecting unit 41 detects an event that interrupts an input operation of the first input unit 11, information is input with the second input unit 13 in place of the first input unit 11 through an input operation.

With the information processing device 1 configured as above, in a case in which the card detecting unit 41 detects an event that interrupts an input operation of the first input unit 11, information is input with the second input unit 13 in place of the first input unit 11 through an input operation. Therefore, even in a state where an input operation is not possible with inputting means that is ordinarily used, the information processing device 1 makes it possible to perform an input operation with the second input unit 13 as alternative means. Moreover, in a case in which the first input unit 11 is configured as a permanent keyboard, i.e. the physical keyboard (the hardware keyboard), the input function of the second input unit 13 may be activated only when an input operation of the first input unit 11 is interrupted; accordingly, the second input unit 13 can be configured as the software keyboard.

In addition, with the information processing device 1, in a case in which the card detecting unit 41 no longer detects an event that interrupts an input operation of the first input unit 11, an input operation for inputting information with the second input unit 13 is prohibited. Therefore, the information processing device 1 can automatically suspend the function of the second input unit 13 when restoring the input function of the first input unit 11 with which an input operation is possible; accordingly, an input operation and the like of the first input unit 11 are not interrupted.

Furthermore, the information processing device 1 includes the display unit 12 and the GUI image display control unit 44.

The display unit 12 displays an image.

The GUI image display control unit 44 controls the display unit 12 to perform display.

The second input unit 13 is configured with the touch panel that is disposed in a laminated manner on the display screen of the display unit 12.

Moreover, the GUI image display control unit 44 controls whether the display unit 12 displays the software keyboard image SK that is used for inputting information through an input operation with an object that touches or approaches the touch panel.

Therefore, since the information processing device 1 does not require another input unit as hardware, the layout of disposing the second input unit 13 is not restricted, in other words, the design flexibility of the device can be enhanced.

In addition, the information processing device 1 includes the R/W unit 21.

The R/W unit 21 performs contactless communication with the contactless IC card 100 via the antenna 14.

The antenna 14 is disposed in the vicinity of the first input unit 11.

The card detecting unit 41 detects communication with the contactless IC card 100 as an event that interrupts an input operation of the first input unit 11.

Therefore, even in a case in which an operation interrupting an input operation of the first input unit 11 is due to communication with the contactless IC card 100, i.e. due to holding the contactless IC card 100 over the first input unit 11, the antenna 14 is not required to be disposed in a position that does not interrupt the operation of the first input unit 11; accordingly, the design freedom of the information processing device 1 can be enhanced.

It should be noted that the present invention is not limited to the abovementioned embodiment, but includes modification, improvement and the like within a scope that can achieve the object of the present invention.

Although the second input unit 13 is configured with the software keyboard in the abovementioned embodiment, it is not limited thereto. The second input unit 13 may be input means that can complement an input operation of the first input unit 11, and may be, for example, a physical keyboard (a hardware keyboard).

Moreover, although the function of the second input unit 13 is achieved by the GUI image display control unit 44 for controlling the display unit to display the QWERTY full keyboard as shown in FIG. 1B in the abovementioned embodiment, it is not limited thereto. In addition, the function of the second input unit 13 may also be achieved by displaying only numeric characters such as an authentication code corresponding to the contactless IC card 100. Furthermore, the function of the second input unit 13 may also be achieved by displaying information corresponding to a running application, i.e. currently active software.

Moreover, in the abovementioned embodiment, the information processing device 1 is configured to detect communication with the contactless IC card 100 as an event that interrupts an input operation of the first input unit 11, thereby detecting the fact that the contactless IC card 100 is held over the first input unit 11, which is an event that interrupts an input operation of the first input unit 11; however, it is not limited thereto. For example, by detecting a communication state or using various types of sensors, the information processing device 1 may be capable of detecting any state related to an event that interrupts an input operation of the first input unit 11.

In addition, although the information processing device 1 according to the present invention has been described as a mobile terminal as an example in the abovementioned embodiment, it is not particularly limited thereto.

For example, the present invention can be applied to electronic devices in general, which include a function such as the input function activation process. More specifically, the present invention can be applied to, for example, an authentication unit, a notebook personal computer, a printer, a television receiver, a video camera, a portable navigation device, cellular telephone, a portable gaming machine, or the like.

The series of processing described above can be executed by way of hardware or software.

In other words, the functional configuration shown in FIG. 3 is merely exemplification, and it is not particularly limited thereto. In other words, it is sufficient for the information processing device 1 to include a function capable of executing the abovementioned series of processing in its entirety, and the functional block for implementing the function is not particularly limited to the example shown in FIG. 3.

Furthermore, a single functional block may be configured with a single hardware unit, a single software unit, or a combination thereof.

In a case in which the series of processing is executed by way of software, a program that configures the software is installed in a computer via a network or a recording medium.

The computer may be a computer incorporated into specialized hardware. Moreover, the computer may be a computer such as a general-purpose personal computer capable of executing various functions by installing various programs.

The recording medium including such a program is configured with not only the removable medium 31 shown in FIG. 2, which is distributed separately from the device main body for providing the program to the user, but also with a recording medium or the like that is provided in a state of being built in the device main body in advance to the user. The removable medium 31 is configured with, for example, a magnetic disk (including a floppy disk), an optical disk, or a magneto-optical disk. The optical disk is configured with, for example, a CD-ROM (Compact Disk-Read Only Memory), a DVD (Digital Versatile Disk) or the like. The magneto-optical disk is configured with an MD (Mini-Disk) or the like. In addition, the recording medium that is provided in a state of being built in the device main body in advance to the user is configured with, for example, the ROM 16 storing programs shown in FIG. 2, a hard disk included in the storage unit 24 shown in FIG. 2, or the like.

It should be noted that, in the present specification, the steps describing the program recorded in the recording medium naturally include processing to be executed in the chronological order, and also include processing to be executed in parallel or individually, not necessarily limited to the chronological order.

Furthermore, in the present specification, terminologies describing a system refer to a whole apparatus configured with a plurality of devices, a plurality of means and the like.

Although some embodiments of the present invention have been described above, the embodiments are merely exemplification, and are not intended to limit the technical scope of the present invention. The present invention can be implemented in other various embodiments, and in addition, modification such as omission or substitution is possible without departing from the scope of the present invention. The embodiments and modification are included in the scope and summary of the invention described in the present specification and the like, and are included in the invention recited in the claims as well as the scope equivalent thereto.

What is claimed is:

1. An information processing device, comprising:
a first input unit which inputs information through an input operation;
a detecting unit which detects an event that interrupts the input operation of the first input unit; and
a second input unit which inputs information through an input operation as an alternative to the first input unit, in a case in which the detecting unit detects the event.

2. The information processing device according to claim 1,
wherein the input operation with the second input unit is prohibited, in a case in which the detecting unit no longer detects the event.

3. The information processing device according to claim 1, further comprising:
a display unit which displays an image; and
a display control unit which controls display of the display unit,
wherein the second input unit is configured with a touch panel that is disposed in a laminated manner on a display screen of the display unit, and
wherein the display control unit controls whether to display a GUI image for inputting information through an input operation of an object that touches or approaches the touch panel.

4. The information processing device according to claim 2, further comprising:
a display unit which displays an image; and
a display control unit which controls display of the display unit,
wherein the second input unit is configured with a touch panel that is disposed in a laminated manner on a display screen of the display unit, and
wherein the display control unit controls whether to display a GUI image for inputting information through an input operation of an object that touches or approaches the touch panel.

5. The information processing device according to claim 1, further comprising:
a reader writer unit which performs contactless communication with a contactless IC card via an antenna,
wherein the antenna is disposed in a vicinity of the first input unit, and
wherein the detecting unit detects communication with the contactless IC card as an event that interrupts the input operation of the first input unit.

6. The information processing device according to claim 2, further comprising:
a reader writer unit which performs contactless communication with a contactless IC card via an antenna,
wherein the antenna is disposed in a vicinity of the first input unit, and
wherein the detecting unit detects communication with the contactless IC card as an event that interrupts the input operation of the first input unit.

7. The information processing device according to claim 3, further comprising:
a reader writer unit which performs contactless communication with a contactless IC card via an antenna,
wherein the antenna is disposed in a vicinity of the first input unit, and
wherein the detecting unit detects communication with the contactless IC card as an event that interrupts the input operation of the first input unit.

8. The information processing device according to claim 4, further comprising:
a reader writer unit which performs contactless communication with a contactless IC card via an antenna,
wherein the antenna is disposed in a vicinity of the first input unit, and
wherein the detecting unit detects communication with the contactless IC card as an event that interrupts the input operation of the first input unit.

9. An information processing method, comprising:
a first inputting step that inputs information through an input operation;
a detecting step that detects an event that interrupts the input operation in the first inputting step; and
a second inputting step that inputs information through an input operation as an alternative to the first inputting step, in a case in which the event is detected in the detecting step.

10. A computer-readable storage medium including a program for causing a computer to execute:
a first inputting step that inputs information through an input operation;
a detecting step that detects an event that interrupts the input operation in the first inputting step; and
a second inputting step that inputs information through an input operation as an alternative to the first inputting step, in a case in which the event is detected in the detecting step.
